(19) United States
(12) Patent Application Publication
(10) Pub. No.: US 2024/0300309 A1
(43) Pub. Date: Sep. 12, 2024

(54) RETRACTABLE PICKUP TRUCK BOX COVER

(71) Applicant: Peragon Enterprises, Inc., Shell Lake, MN (US)

(72) Inventors: Heath R. Copp, Trego, WI (US); Jake William Myre, Rice Lake, WI (US); Noah William Marach, Rice Lake, WI (US)

(21) Appl. No.: 18/537,067

(22) Filed: May 23, 2024

Related U.S. Application Data
(60) Provisional application No. 63/470,385, filed on Jun. 1, 2023.
(60) Provisional application No. 63/387,063, filed on Dec. 12, 2022.

(51) Int. Cl. B60J 7/14

(52) U.S. Cl. CPC B60J 7/141

(57) ABSTRACT

A retractable cover system including a plurality of brackets mountable within a box of a pickup truck, a driver side rail and a passenger side rail operably couplable to the plurality of brackets, a plurality of panels having a plurality of bearings configured to engage the driver side rail and the passenger side rail to transition between an opened position and a closed position, and a front cross piece operably coupling the driver side rail to the passenger side rail, wherein the front cross piece includes a leading edge defining a curve generally conformed to at least one of a forward end of the box or a rear of a cab of the pickup truck.

### CROSS-REFERENCE TO RELATED APPLICATION

This application is being filed on Dec. 12, 2023, as a U.S. Utility Application and claims the benefit of U.S. Provisional Application No. 63/387,063, filed Dec. 12, 2022, and U.S. Provisional Application No. 63/470,385, filed Jun. 1, 2023, the disclosures of which are hereby incorporated by reference in their entireties.

### TECHNICAL FIELD

The present disclosure relates generally to the field of pickup truck accessories, and more particularly to a retractable cover system for a truck box of a pickup truck.

### BACKGROUND

Pickup trucks typically include a pickup truck box positioned toward a rear end of the pickup truck and behind a cab of the pickup truck. The pickup truck box, as delivered from the factory, typically includes an opening behind a front wall of the pickup truck box and between a right and a left sidewall of the pickup truck box. At a rear end of the pickup truck box, an end gate is typically positioned between the right and the left sidewalls of the pickup truck box. The end gate is typically foldable to an open position that pivots about a horizontally oriented axis that is positioned adjacent to a bed of the pickup truck box. The front wall, the right and the left sidewalls, and the end gate of the pickup truck box typically extend upward from the bed of the pickup truck box. The opening of the pickup truck box typically extends around a perimeter of the pickup truck box and includes tops of the front wall, the right and left sidewalls, and the end gate. The opening of the pickup truck box allows the pickup truck box to haul irregularly shaped and large objects that may extend above the tops of the front wall, the right and the left sidewalls, and the end gate, to allow the objects to extend above the cab of the pickup. However, the opening of the pickup truck box does not provide enclosed storage that is often desired. The opening of the pickup truck box may further create increased aerodynamic drag on the pickup truck, resulting in increased fuel usage.

A variety of pickup truck box covers have been developed, and such covers are available in the marketplace. The pickup truck box covers that are available in the marketplace typically cover the opening of the pickup truck box and extend around the perimeter of the opening. The pickup truck box covers typically have a configuration that covers or substantially covers the opening and may further provide a mechanism to lock the pickup truck box cover in an extended or covered configuration. The pickup truck box covers may also include a retracted configuration wherein the pickup truck box cover is folded or otherwise moved out of the way to substantially uncover the pickup truck box opening. The pickup truck box covers may further be removed from the pickup truck box and thereby free-up the entire pickup truck box or substantially the entire pickup truck box for use. U.S. Pat. Nos. 6,321,819; 9,707,833; and U.S. Pat. No. 9,296,285 to Copp et al., disclose a retractable cover system for use in covering a pickup truck box and is hereby incorporated by reference in its entirety. Peragon Enterprises, Inc. of Spooner, Wis. 54801 sells retractable cover systems for covering the opening of a pickup truck box.

### SUMMARY

Embodiments of the present disclosure provide a retractable cover system that is much easier to install than cover systems of the prior art. In particular, embodiments of the present disclosure provide a retractable cover system that can be completely installed piece-by-piece within a pickup truck box, as opposed to being partially assembled outside of the pickup truck box and then manually transferred into the pickup truck box (typically by at least two people). Accordingly, embodiments of the present disclosure provide a retractable cover system that can be installed by a single person, typically within a time span of less than about 45 minutes, which represents a significant time savings over installation of cover systems of the prior art. Moreover, the retractable cover system of the present disclosure includes a number of features configured to make it easier for a user to perform fine tune adjustment of the retractable cover system for optimum performance.

Unlike cover systems of the prior art, embodiments of the present disclosure provide a retractable cover system that is configured to lock and unlock without the use of a key locking deadbolt. In particular, the retractable cover system of the present disclosure employs the combination of a pushrod and lift ramp system to lock and unlock the cover, thereby enabling the cover to transition from a locked, secure truck bed, to a fully open, accessible truck bed in seconds, without the need for a key or having to walk alongside of the cover to initiate the opening sequence (as is often required with cover systems of the prior art). Rather, embodiments of the present disclosure enable manipulation of the retractable cover system from the tailgate.

In the fully retracted configuration, the retractable cover system of the present disclosure retracts into a space of less than 6 inches. When desired, the panels of the retractable cover system can be removed from the truck bed without the use of any tools, typically in less than 30 seconds, thereby freeing the entire truck bed for cargo. Further, embodiments of the present disclosure enable the retractable cover system to be secured in a partially opened configuration, where the truck bed is partially covered by the retractable cover system.

The retractable cover systems of the present disclosure can be crafted of a solid aluminum construction, and can be painted in a variety of colors, including many popular truck colors, thereby enabling users to create a unique look that completes their truck. In some embodiments, the retractable cover system can include a front cross piece specifically shaped to conform to a front of the truck box/rear of the cab of the truck to inhibit the intrusion of moisture into the truck bed, when the retractable cover system is in the closed configuration. Moreover, in some embodiments, the front cross piece can be configured as a structural bridge configured to support an external load of up to about 150 pounds without buckling, thereby serving as an ideal mounting surface for a variety of accessories.

One aspect of the present disclosure provides a box cover having multiple panels and moving via bearings along a driver side rail and passenger side rail, coupled to a plurality of brackets. A cross piece having a leading edge with a curve closely conformed to at least one end of the box is also provided. The cross piece may be comprised of sheet metal, and may be a single unitary piece. In certain embodiments the cross piece may also serve other functional purposes, such as a mounting anchor for other accessories, or as a bridge between the driver and passenger side which can bear the load weight of cargo. The form-fitting nature of the cross piece can also serve to inhibit moisture from intruding into the pickup box.

In another aspect of the retractable cover system, at least one of the plurality of brackets has a slot through which a fastener can be positioned to aid in adjusting a top surface of each bracket relative to a top perimeter of the box of the pickup truck. In operation, push rods and one or more lift ramps are utilized to move a series of panels. The mounting brackets may be comprised of fixtures to the cab wall and tailgate such that no permanent modifications are necessary to the pickup box. The installation can be adapted to any of a number of specific truck makes and models. After complete installation, the retractable box cover system is positioned such that continued use of the feature remains possible. Further, the top surface of each bracket can be adjusted relative to the top perimeter of the box with the aid of a specialized installation tool. The tool serves as a benchmark for measuring one or more distances of one or more brackets relative to the top perimeter of the truck box.

In another aspect, the retractable cover system contains a multitude of panels having a plurality of bearings received in and moving along the driver side rail and passenger side rail. The panels may be moved and fixated from a fully closed position into a partly open position and further into a fully open position. The retractable cover system contains at least one lift ramp which is shiftable relative to the driver side rail and passenger side rail between a first position, a second position, and a locked position. The panels can be moved from their locked position via applied force, which moves at least one bearing from at least one ramp surface to another ramp surface, thereby disengaging the bearing and allowing it to move along the ramp surface. Further force allows the bearing to move along the driver side and passenger side rails. As the bearings move, their associated panels do as well, which fold into a cradled position, thereby locking the panels. The panels and bearings may be moved mechanically via a push rod. The system can be locked by the aid of a protrusion of a slider mechanism nestled within a first detent. The system further contains a second detent configured as a slot to enable at least one lift ramp to shift between the first and second transition positions against a biasing member, such as a coiled spring.

In yet another aspect of the retractable cover system, a plurality of bearings and panels within the driver side rail and the passenger side rail are transitional relative to the rails between an open position and a closed position. The system contains at least one lift ramp, shiftable relative to the driver side rail and passenger side rail between a locked position and a transition position. Manipulation of the lift ramp from a locked position to a transition position causes a bearing to transition from a cradle position to an unlocked position along a ramp surface. The lift ramp itself forms a bearing surface wherein shifting between the locked and unlocked positions causes the bearing surface to also shift relative to the driver side and opens a bearing aperture, thereby allowing a bearing to slide through. The system also features a stationary ramp which guides the plurality of bearings to pass through the open bearing aperture. The aforementioned ramps may be moved manually by a push rod. The ramps can be maintained in a locked position with the aid of a protrusion of a slider mechanism which resides within a first detent, which can thereafter be shifted to a second detent which allows movement.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the examples disclosed herein are based.

### DESCRIPTION OF THE DRAWINGS

The following drawings are illustrative of particular examples of the present disclosure and therefore do not limit the scope of the present disclosure. Examples of the present disclosure will hereinafter be described in conjunction with the appended drawings, wherein like numerals denote like elements.

FIG. 1 is a perspective view of a retractable cover system exploded away from a truck bed, in accordance with an embodiment of the disclosure.

FIG. 2A is a perspective view of a retractable cover system installed in a truck box, shown in a closed position, in accordance with an embodiment of the disclosure.

FIG. 2B is a perspective view of a retractable cover system installed in a truck box, shown in a partially open position.

FIG. 2C is a perspective view of a retractable cover system installed in a truck box, shown in an open position, in accordance with an embodiment of the disclosure.

FIG. 3 is an exploded view of a retractable cover system, in accordance with an embodiment of the disclosure.

FIG. 4A is a perspective view of a driver side tailgate bracket, in accordance with an embodiment of the disclosure.

FIG. 4B is a perspective view of a driver side cab bracket, in accordance with an embodiment of the disclosure.

FIG. 5A is a perspective view of a driver side tailgate bracket mounted in a truck box, in accordance with an embodiment of the disclosure.

FIG. 5B is a perspective view of a driver side cab bracket mounted in a truck box, in accordance with an embodiment of the disclosure.

FIG. 6 is a perspective view of an installation tool, in accordance with an embodiment of the disclosure.

FIG. 7A is a perspective view of a front cross piece, in accordance with an embodiment of the disclosure.

FIG. 7B is a detail view of FIG. 6A, showing a closeup view of one of the ledges, in accordance with an embodiment of the disclosure.

FIG. 7C is a top view of a front cross piece, showing an exemplary leading-edge curve, in accordance with an embodiment of the disclosure.

FIG. 8 is a perspective view of a front cross piece exploded away from a truck box, in accordance with an embodiment of the disclosure.

FIG. 9A is a left side view of a driver side rail showing associated ramps and brackets.

FIG. 9B is a bottom perspective view of a driver side rail attached to a front cross piece with associated ramps and brackets.

FIG. 10A is a close up, perspective view of a driver side rail coupled to a front cross piece, in accordance with an embodiment of the disclosure.

FIG. 10B is a close-up, exploded perspective view of a coupling between a side rail and a cab bracket, in accordance with an embodiment of the disclosure.

FIG. 10C is a close-up, perspective view of a coupling between a side rail and a tailgate bracket, in accordance with an embodiment of the disclosure.

FIG. 11A is a perspective view depicting an installation of a pushrod with other components of a retractable cover system, in accordance with an embodiment of the disclosure.

FIG. 11B is a top perspective view of a driver side rail showing the pushrod and associated ramps and brackets, in accordance with an embodiment of the disclosure.

FIG. 11C is a closeup view of a driver side rail assembly focusing on a ramp and terminal end of a push rod, in accordance with an embodiment of the disclosure.

FIG. 12 is a perspective view of a plurality of panels and associated bearings, in accordance with an embodiment of the disclosure.

FIG. 13A is a partial, perspective view depicting a plurality of panels, in accordance with an embodiment of the disclosure.

FIG. 13B is a partial, perspective view depicting a plurality of panels, in accordance with an embodiment of the disclosure.

FIG. 14A is a perspective view depicting installation of a plurality of panels with other components of a retractable cover system, in accordance with an embodiment of the disclosure.

FIG. 14B is a close-up, perspective view depicting the installation of the plurality of panels of FIG. 14A with other components of a retractable cover system, in accordance with an embodiment of the disclosure.

FIG. 15 is a partial, perspective view depicting engagement of a pin of a plurality of panels with an aperture of at least one of a side rail or front cross member of a retractable cover system, in accordance with an embodiment of the disclosure.

FIG. 16 is a partial, perspective view depicting a plurality of bearings of a plurality of panels position within a bearing channel defined by a side rail of a retractable cover system, in accordance with an embodiment of the disclosure.

FIG. 17 is an end view of a driver side rail assembly, showing attached panels and bearings.

FIG. 18 is a schematic, end view depicting bearings of a plurality of panels position within a bearing channel defined by a pair of side rails, in accordance with an embodiment of the disclosure.

FIG. 19A is a perspective view depicting an installed retractable cover system in a closed configuration, in accordance with an embodiment of the disclosure.

FIG. 19B is a perspective view depicting the installed retractable cover system of FIG. 19A in an open configuration, in accordance with an embodiment of the disclosure.

FIG. 20 is a side view of a lift ramp assembly showing a first position of a bearing and associated panels. In this position, the shown panels of the retractable cover create an opening to the truck bed.

FIG. 20B is a side view of a lift ramp assembly showing a second position of a bearing and associated panels. In this position, the shown panels of the retractable cover close off the truck bed.

FIG. 21A shows an exploded side view showing features of a lift ramp assembly.

FIG. 21B shows a first position of a protrusion interacting with a first detent.

FIG. 21C shows a second position of a protrusion interacting with a second detent after actuation by a push rod.

FIG. 22A is side view of a lift ramp in the aft position.

FIG. 22B is a side view of a lift ramp in the forward position, showing a bearing moving shown the ramp surface.

FIG. 23A is a perspective view depicting a lift ramp including a movable ramp surface in accordance with an embodiment of the disclosure.

FIG. 23B is a side view of the lift ramp of FIG. 23A.

FIG. 24A is a perspective view depicting a lift ramp including a movable ramp surface in accordance with an alternative embodiment of the disclosure.

FIG. 24B is a side view of the lift ramp of FIG. 24A.

### DETAILED DESCRIPTION

Various examples will be described in detail with reference to the drawings, wherein like reference numerals represent like parts and assemblies throughout the several views.

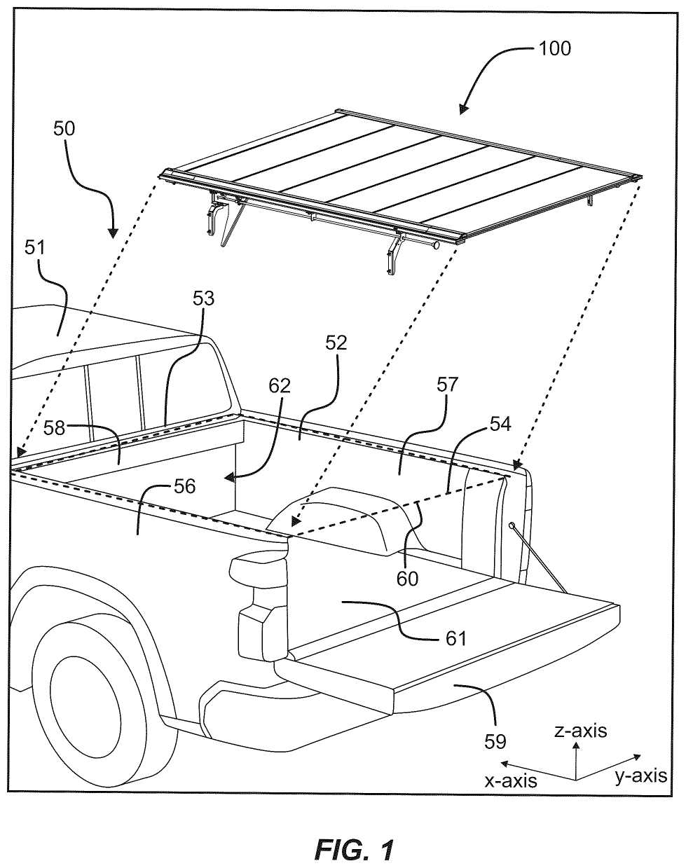

Referring to FIG. 1, a pickup truck 50 with an installed retractable cover system 100 is depicted in accordance with an embodiment of the disclosure. The pickup truck 50 includes a cab 51 and a pickup truck box 52 positioned behind the cab 51 and extending to a rear bumper of the pickup truck 50. The pickup truck box 52 extends between a forward end 53 and a rearward end 54, with the forward end 53 and the rearward end 54 spaced apart along a longitudinal (e.g., fore-aft) x-axis of the pickup truck 50.

The pickup truck box 52 includes a driver side wall 56 and an opposite passenger side wall 57. The driver side wall 56 and the passenger side wall 57 may generically be sides of the pickup truck box 52, spaced apart along a lateral (e.g., right-left) y-axis of the pickup truck 50. A front wall 58 of the pickup truck box 52 may extend between the driver side wall 56 and the passenger side wall 57. Likewise, a tailgate 59, which may be selectively opened and closed, can extend between the driver side wall 56 and the passenger side wall 57. Collectively, the driver side wall 56, the passenger side wall 57, the front wall 58, and the tailgate 59 can form a wall generally extending upwardly from a bed 61 of the pickup truck box 52 to define an open top perimeter 60 of the pickup truck box 52. An interior 62 of the pickup truck box 52 may further be defined by a pair of wheel wells that are generally adjacent the bed 61 and extend upwardly over a portion of the driver side wall 56 and the passenger side wall 57.

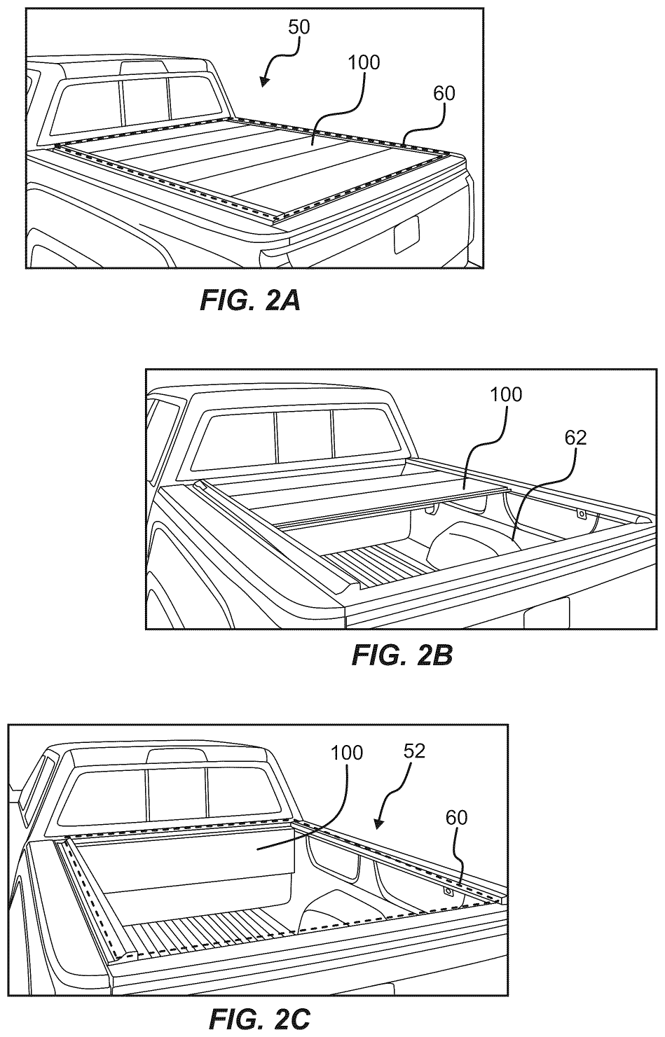

With additional reference to FIGS. 2A-2C, the retractable cover system 100 can be installed in the pickup truck 50 to provide a movable cover over the top perimeter 60 of the pickup truck box 52. In particular, the retractable cover system 100 can transition between a closed position (as depicted in FIG. 2A), in which the top perimeter 60 of the pickup truck box 52 is substantially sealed, and an open position (as depicted in FIG. 2C) in which the top perimeter 60 of the pickup truck box 52 is substantially open enabling access to the interior 62 of the pickup truck box 52. FIG. 2B depicts the retractable cover system 100 in a partially open/closed position between the fully open position and the fully closed position.

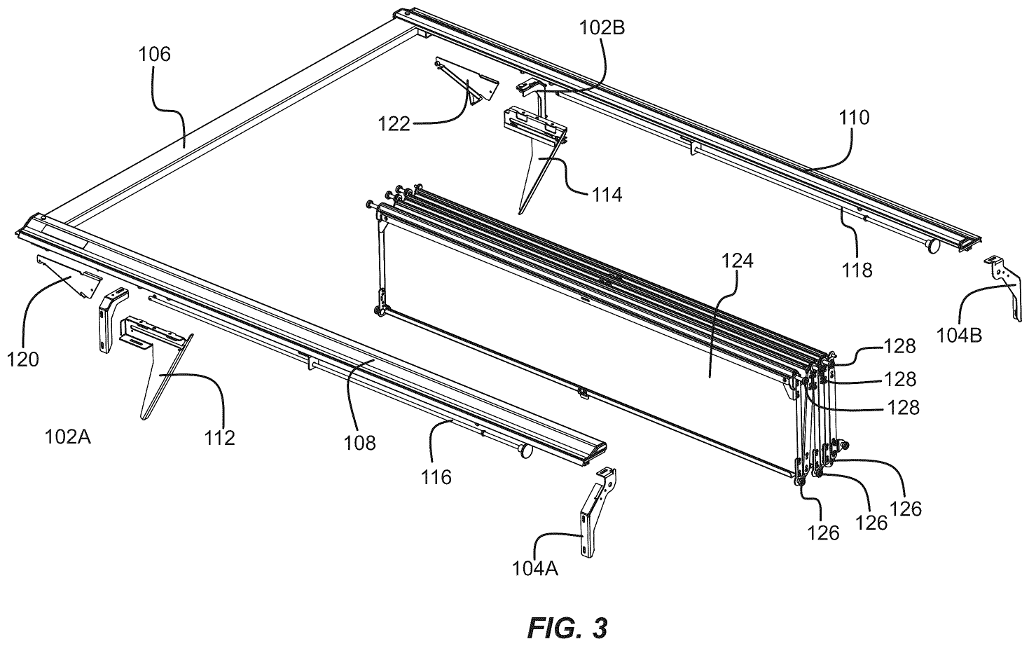

As depicted in FIG. 3, the retractable cover system 100 can generally include a plurality of brackets 102A-B, 104A-B, a front cross piece 106, a pair of rails 108, 110, a pair of stationary ramps 112, 114, a pair of pushrods 116, 118, a pair of lift ramps 120, 122, and a plurality of panels 124 upon which a plurality of long bearings 126 and short bearings 128 are mounted.

Installation of the retractable cover system 100 into a pickup truck box 52 can generally begin with installation of the plurality of brackets 102A-B, 104A-B. The plurality of brackets 102A-B, 104A-B can include a pair of cab brackets 102A-B mountable to a forward portion of the driver and passenger side walls 56, 57 of the pickup truck box 52, and a pair of tailgate brackets 104A-B mountable to an aft portion of the driver and passenger side walls 56, 57.

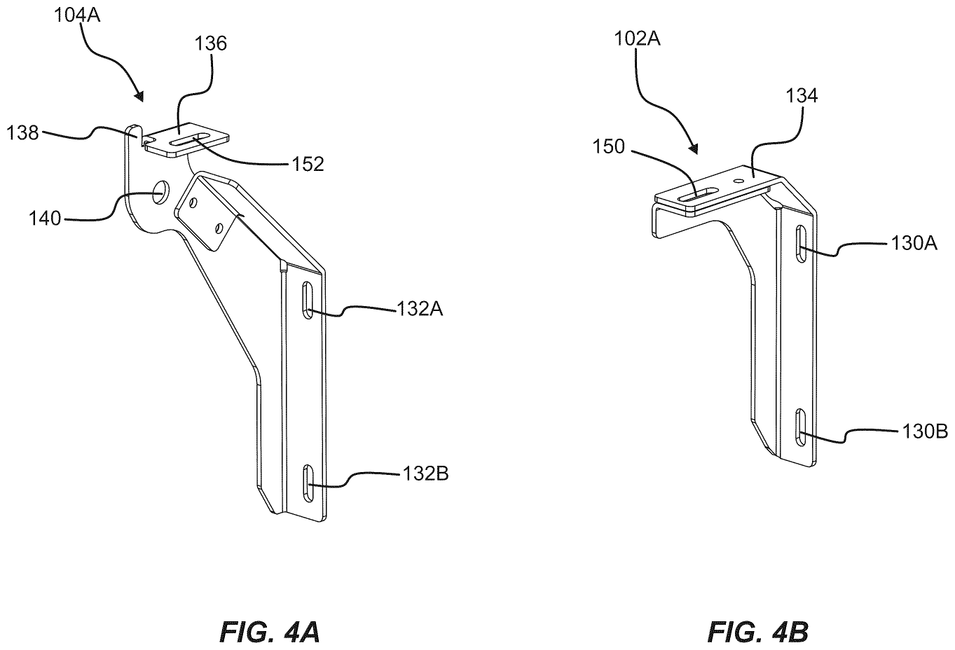

With additional reference to FIGS. 4A-B, close-up views of the driver side cab bracket 102A and the driver side tailgate bracket 104A are depicted in accordance with an embodiment of the disclosure. In embodiments, the cab bracket 102A and the tailgate bracket 104A can include one or more slots 130A-B, 132A-B configured to enable a fastener (e.g., threaded member, etc.) to pass therethrough thereby enabling the cab bracket 102A and the tailgate bracket 104A to be selectively couplable to the driver side wall 56. In embodiments, the passenger side cab bracket 102B and passenger side tailgate bracket 104A can include the same slots as defined by the driver side cab bracket 102A and tailgate bracket 104A. For example, in one embodiment, the driver side cab bracket 102A and the passenger side cab bracket 102B, and the driver side tailgate bracket 104A and the passenger side tailgate bracket 104B can be configured as mirror images of one another.

In embodiments, each of the driver and passenger cab brackets 102A-B and driver and passenger tailgate brackets 104A-B can be adapted to be operably coupled to features defined within the pickup truck box 52 of particular truck makes and models. For example, specific driver and passenger cab brackets 102A-B and driver and passenger tailgate brackets 104A-B can be manufactured for specific pickup trucks 50, including, but not limited to Ford F150, Ford F250, Ford F350, Ford F450, Ford Ranger, Ford Raptor, Ford Sport Trac, Chevrolet Colorado, Chevrolet S-10, Chevrolet Silverado 1500, Chevrolet Silverado 2500, Chevrolet Silverado 3500, GMC Canyon, GMC Sierra 1500, GMC Sierra 2500, GMC Sierra 3500, GMC Sonoma, Dodge Ram 1500, Dodge Ram 2500, Dodge Ram 3500, Nissan Titan, Nissan Frontier, Toyota Tacoma, Toyota Tundra, Honda Ridgeline, and Lincoln Mark LT, among others.

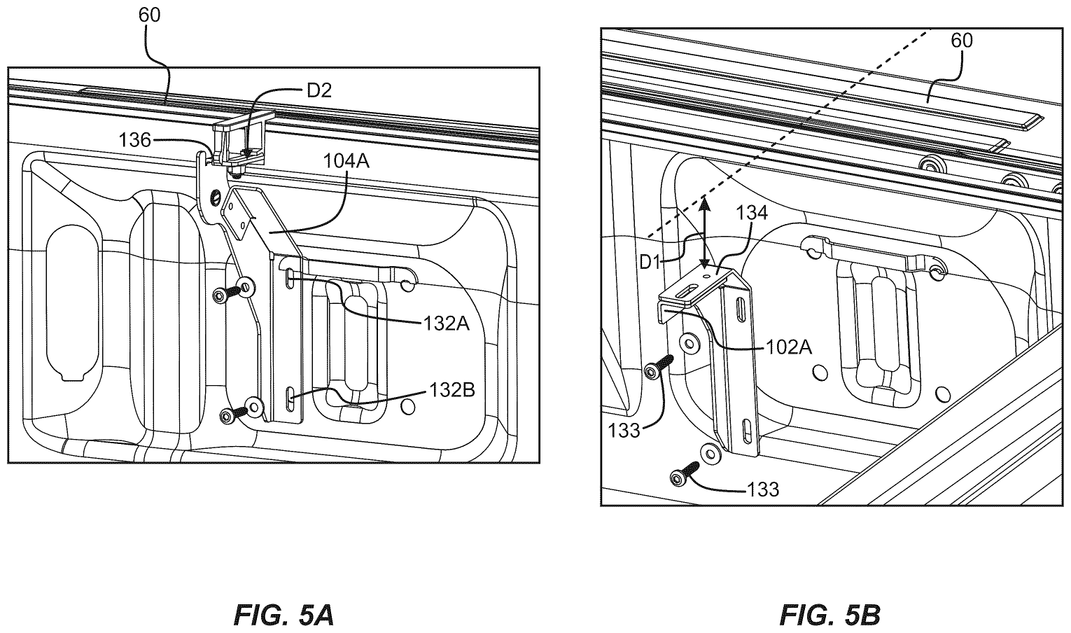

For example, with additional reference to FIGS. 5A-B, the brackets 102A-B, 104A-B can be mounted to existing features, such as gear tiedowns or threaded apertures, such that no modifications (e.g., drilling, welding etc.) is necessary to affix the brackets 102A-B, 104A-B within the pickup truck box 52 of the pickup truck 50. Although the brackets 102A-B and 104A-B are depicted as being couplable to threaded apertures defined in the pickup truck box 52, in other embodiments, the brackets 102A-B and 104A-B can be defined as clamps configured to clamp onto one or more features defined by the pickup truck box 52. Moreover, where possible, the brackets 102A-B, 104A-B can be mounted in a manner that enables continued use of the feature (e.g., gear tiedown, etc.) after complete installation of the retractable cover system 100.

Each of the cab bracket 102A and the tailgate bracket 104A can define a top surface 134, 136 (as depicted in FIGS. 4A-B), which during installation can be mounted a desired distance below the top perimeter 60 of the pickup truck box 52. For example, as depicted in FIG. 5A, the top surface 134 of the cab bracket 102A can be positioned at a first distance (D1) below the top perimeter 60, and as depicted in FIG. 5B, the top surface 136 of the tailgate bracket 104A at a second distance (D2), wherein the first distance (D1) is different than the second distance (D2); although the distances may differ between truck makes and models. As shown in FIGS. 5A-B, the one or more slots 130A-B, 132A-B defined by the cab bracket 102A and the tailgate bracket 104A enable a height of the cab bracket 102A and the tailgate bracket 104A to be adjusted vertically relative to the pickup truck box 52 prior to tightening of the fasteners 133 mounting the cab bracket 102A and the tailgate bracket 104A to the driver side wall 56.

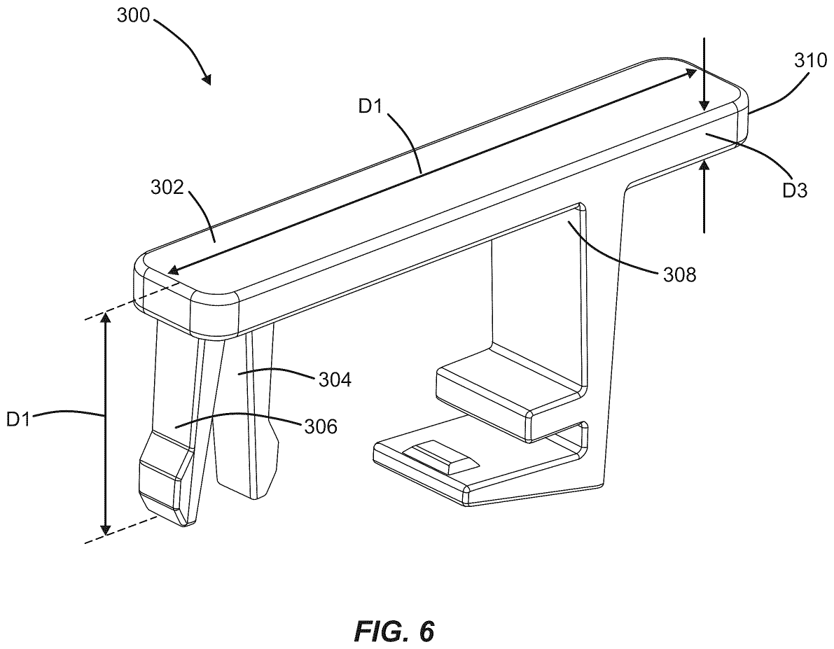

In some embodiments, an installation tool 300 (depicted in FIG. 6) can be used to establish a predetermined vertical height spacing when securing the brackets 102A-B, 104A-B to the driver and passenger side walls 56, 57. For example, in some embodiments the installation tool 300 can include a first member 302 extending along a first axis, with a second member 304 (e.g., in the form of a fork 306) extending along a second axis substantially orthogonal to the first axis. With the first member 302 of the installation tool 300 resting on the top perimeter 60 of the pickup truck box 52, a height defined by the fork 306 can be used as a benchmark to establish the first distance (D1).

With continued reference to FIG. 4A, in some embodiments, at least one of the brackets 104A can define a tab 138, which can serve as an aid in retaining rails 108, 110 during installation. Further, in some embodiments, at least one of the brackets 104A can define an aperture 140 configured to enable a portion of the pushrod 116, 118 to pass therethrough.

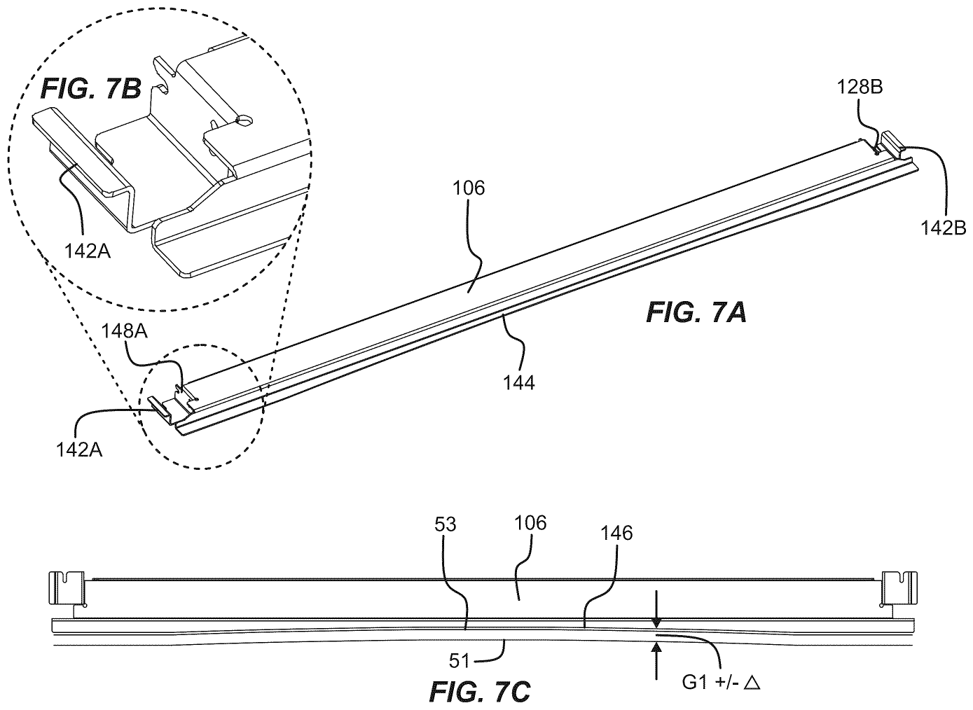

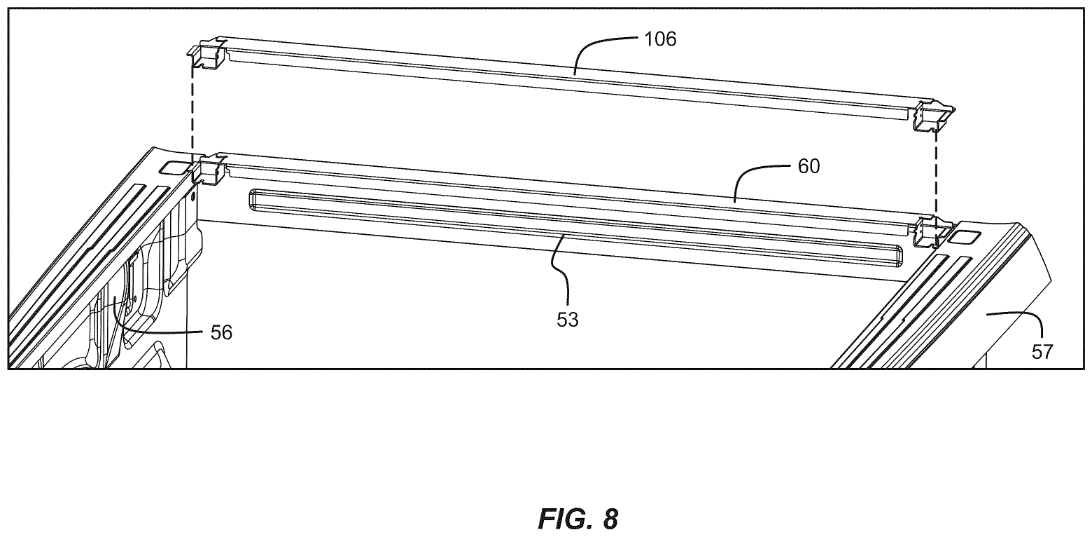

The front cross piece 106 can be positioned within the pickup truck box 52 concurrently with mounting of the cab and tailgate brackets 102A-B, 104A-B. With additional reference to FIGS. 7A-C and 8, initially the front cross piece 106 can be positioned within the pickup truck box 52 such that a pair of ledges 142A-B rest on the top perimeter 60 of the pickup truck box 52, thereby establishing a vertical height of the front cross piece 106 relative to the pickup truck box 52. Accordingly, in some embodiments, the front cross piece 106 is self-supporting. A lateral position of the front cross piece 106 can be adjusted to generally center the front cross piece 106 relative to the driver and passenger side walls 56, 57. The front cross piece 106 can be pushed forward within the pickup truck box 52 to establish at least a temporary longitudinal position of the front cross piece 106 relative to the pickup truck box 52.

In some embodiments, the front cross piece 106 can be a unitary or monolithically formed member constructed out of a variety of materials (e.g., sheet metal, reinforced fiberglass, or the like) having a structural rigidity sufficient to serve as a mounting surface for a variety of accessories. For example, in some embodiments, the front cross piece 106 can be configured to form a bridge between the driver and passenger side walls 56, 57 capable of supporting a load of at least one of 100 pounds, 125 pounds, 150 pounds, 175 pounds, 200 pounds, 250 pounds, 300 pounds, etc. without buckling. In some embodiments, a leading edge 144 of the front cross piece 106 can define a curve 146. For example, as best depicted in FIG. 7C, in some embodiments, the shape of the curve 146 can be generally conformed to at least one of the forward end 53 of the pickup truck box 52 and/or a rear of the cab 51, such that a gap distance (G1) between a forward end 53 of the pickup truck box 52 or a rear of the cab 51 and the curve 146 is substantially uniform (e.g., having a gap distance variance (Δ) of not more than at least one of ±½ inch, ±¼ inch, ±⅛ inch, etc.) laterally across the leading edge 144 between the driver side wall 56 and the passenger side wall 57.

In addition to improving the overall aesthetics of the retractable cover system 100, the curve 146 can provide improved sealing between the retractable cover system and the top perimeter 60 of the pickup truck box 52, particularly over cover systems that employ a substantially conventional crossmember with a straight or linear leading edge. In particular, cover systems employing a crossmember with a straight or linear edge can have significant fluctuations in the gap distance (e.g., having a gap distance variance greater than ±½ inch) defined between forward end 53 of the pickup truck box 52 or a rear of the cab 51, potentially exposing the interior 62 of the pickup truck box 52 to moisture intrusion, particularly from wind driven rain while driving. Further, in some embodiments, the curved front cross piece 106 can reduce wind turbulence and associated noises. The front cross piece 106 of the present disclosure addresses the variable gap problem with the introduction of the curve 146 along the leading edge 144 to create a substantially uniform gap distance. To further inhibit moisture intrusion, in some embodiments a seal can be positioned between the front cross piece 106 and the forward end 53 of the pickup truck box 52.

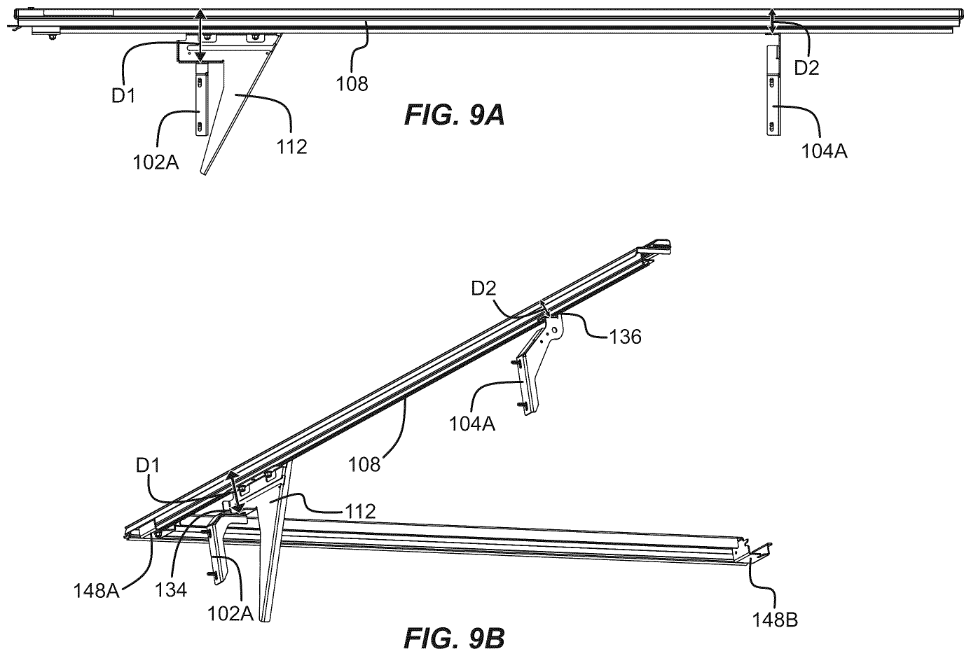

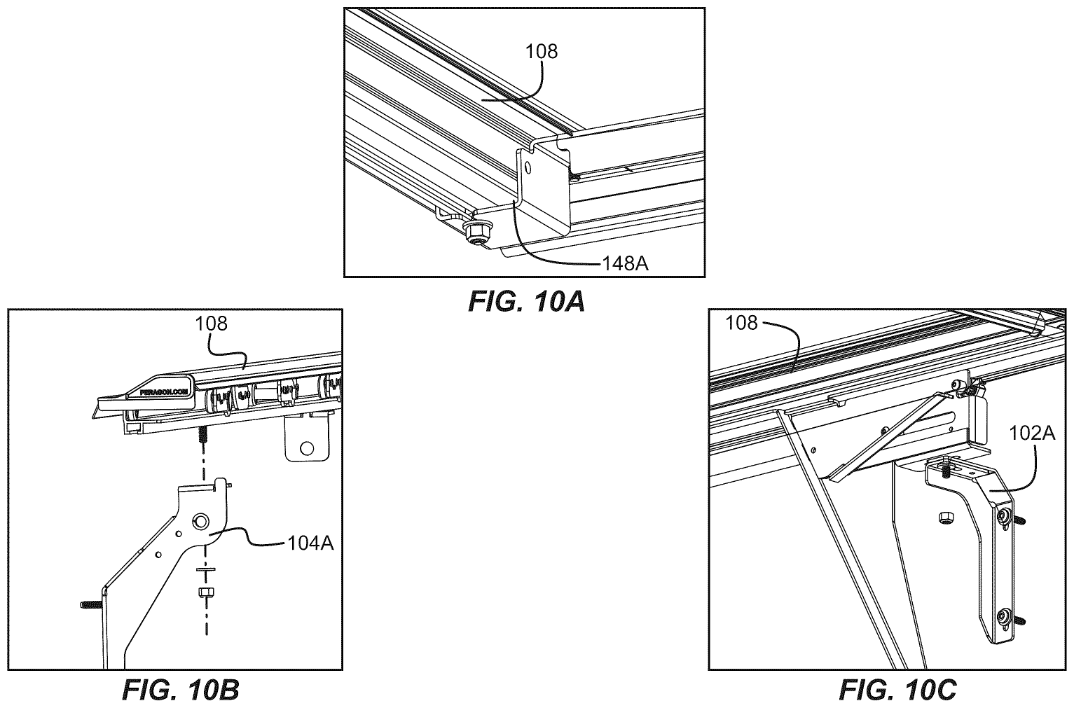

With the brackets 102A-B and 104A-B, and the front cross piece 106 installed, as depicted in FIGS. 9A-B and 10A-C, the rails 108, 110 and stationary ramps 112, 114 can be installed within the pickup truck box 52. In some embodiments, the front cross piece 106 can define a pair of rail saddles 148A/B (as best depicted in FIGS. 7B and 10A) positioned on opposing ends of the front cross piece 106 to receive a forward portion of the rails 108, 110. Other portions of the rails 108, 110 and portions of the stationary ramps 112, 114 can be positioned on the top surfaces 134, 136 of the brackets 102A-B and 104A-B. The forward portion of the rails 108, 110 can be secured to the front cross piece 106 with one or more fasteners, while other portions of the rails 108, 110 can be temporarily held in position relative to the brackets 104A-B by tabs 138. The rails 108, 110 can be more permanently secured to the brackets 102A-B, 104A-B with one or more fasteners traversing through respective the apertures 150, 152 defined in the top surfaces 134, 136 of the brackets 102A-B, 104A-B (as best depicted in FIGS. 4A-B). Initially, the fasteners can be left in a partially secured state, such that the rails 108, 110 are secured to the front cross piece 106 and brackets 102A-B, 104A-B, while still permitting limited adjustment in the lateral and longitudinal directions before the fasteners are fully tightened to lock the rails 108, 110 in position. Accordingly, in some embodiments, stationary ramps 112, 114 can be fastened to the rails 108, 110 prior to installation in the pickup truck box 52. In other embodiments, the stationary ramps 112, 114 and the rails 108, 110 can be affixed together as a unitary member.

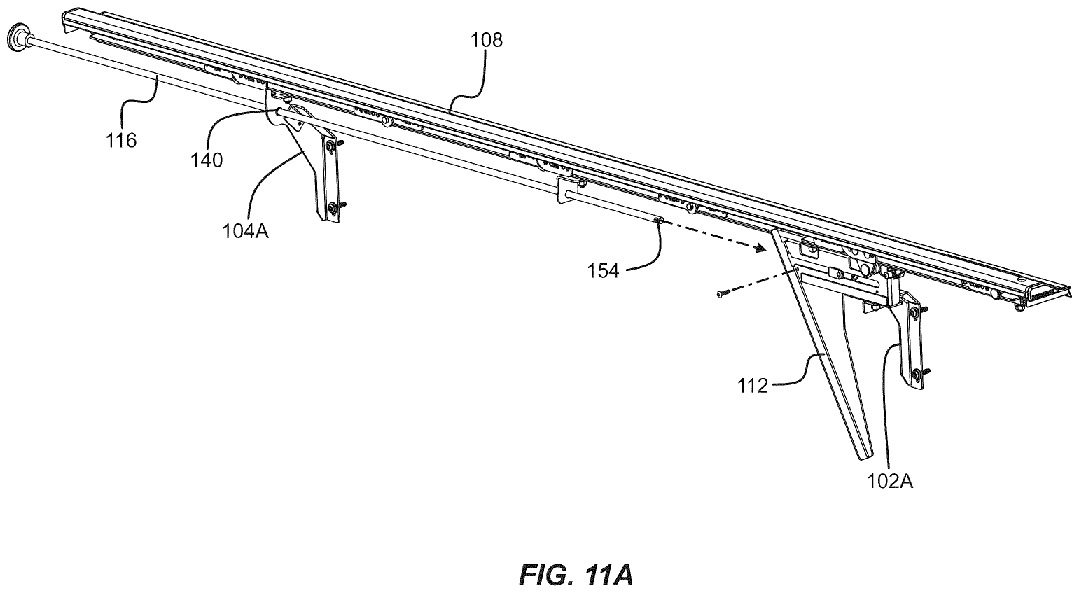

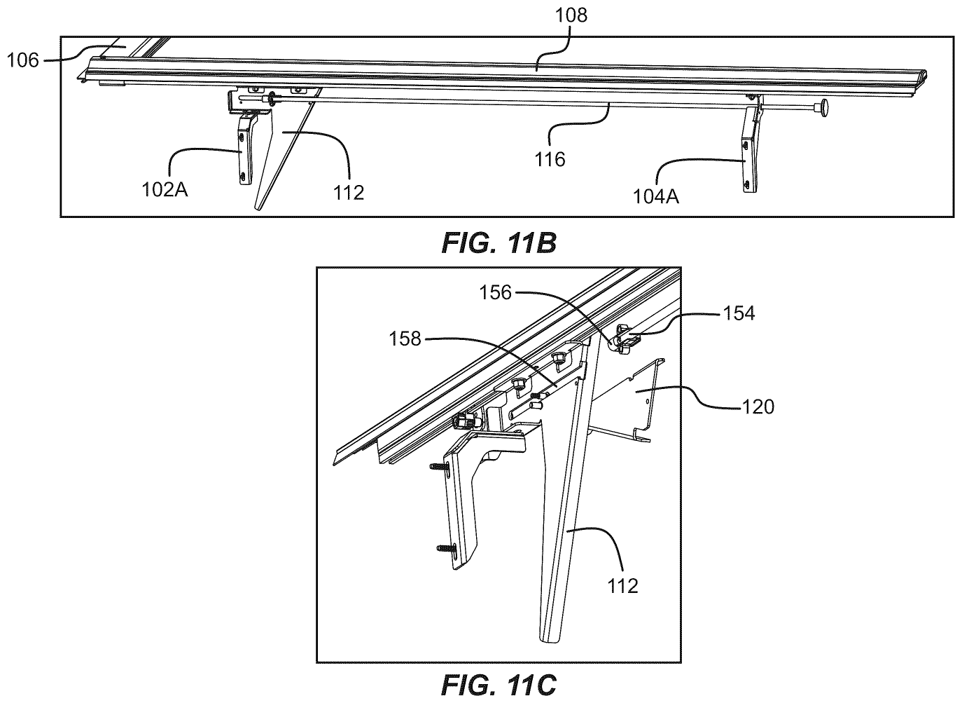

The pushrods 116, 118 and lift ramps 120, 122 can then be installed. With additional reference to FIGS. 11A-C, the pushrod 116 can be inserted through the apertures 140 of bracket 104A. A terminal end 154 of the pushrod 116 can be coupled to a slider mechanism 156 configured to be slidably received within a channel 158 defined by the stationary ramp 112 (as best depicted in FIG. 11C). Thereafter, the slider mechanism 156 can be operably coupled to the lift ramp 120, such that longitudinal shifting of the slider mechanism 156 relative to channel 158 (via longitudinal movement of the pushrod 116) causes longitudinal shifting of the lift ramp 120 relative to the stationary ramp 112. The passenger side push rod 118 and lift ramp 122 can be installed in a similar manner.

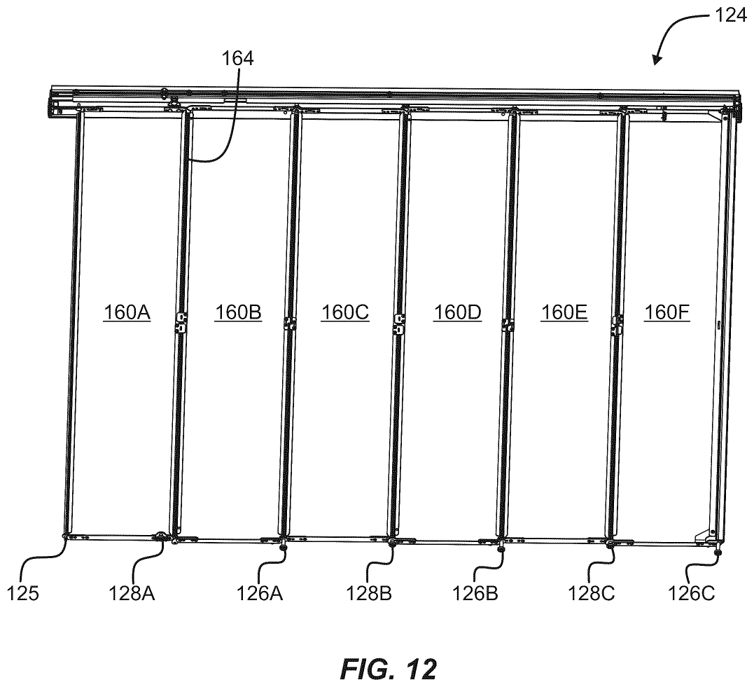

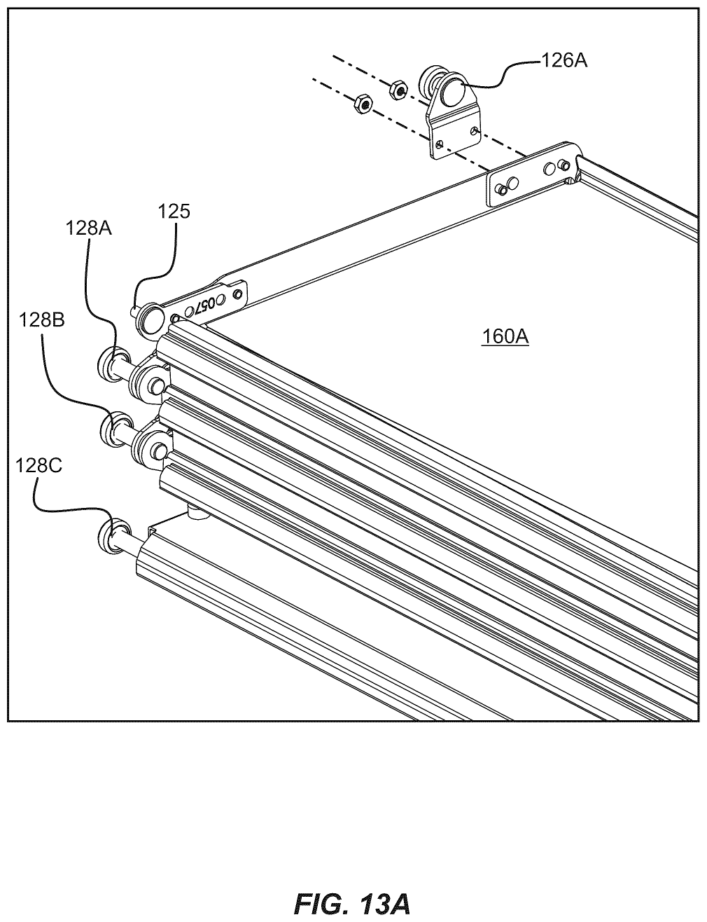

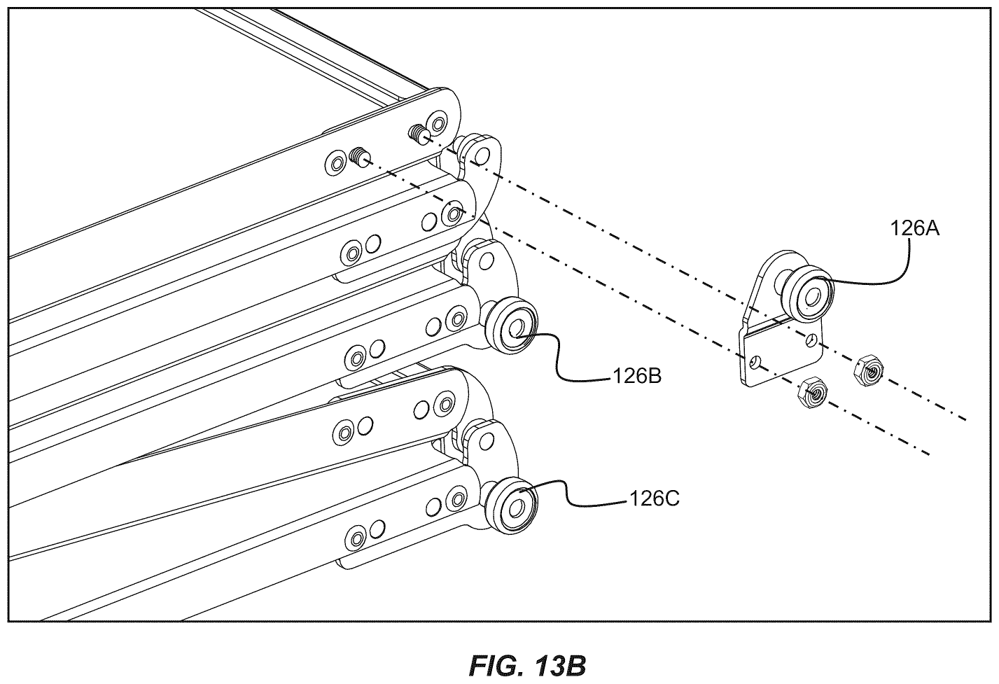

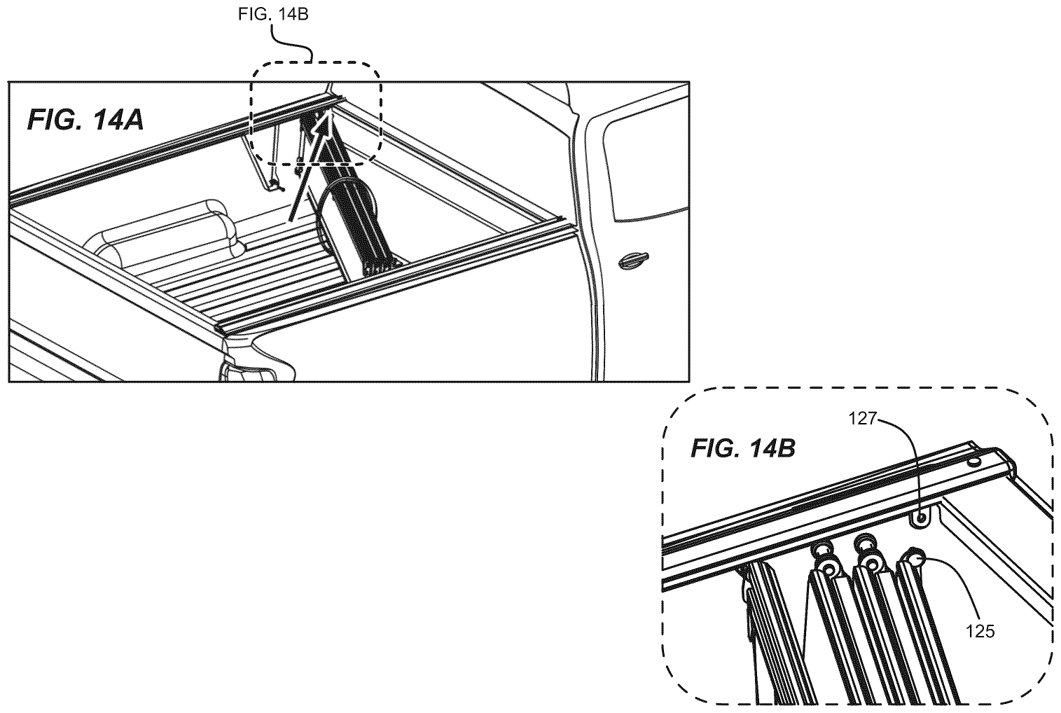

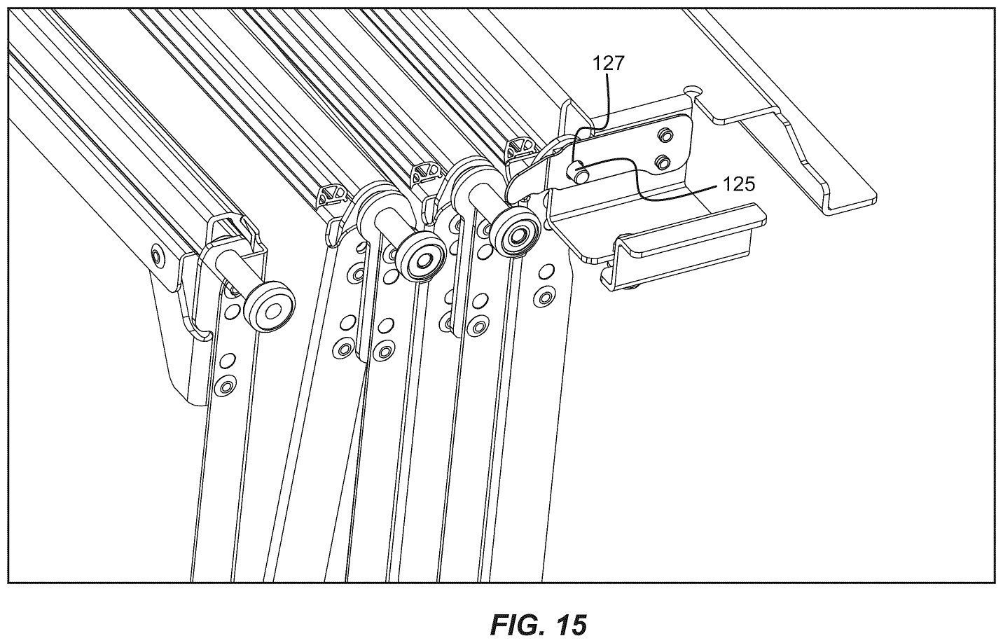

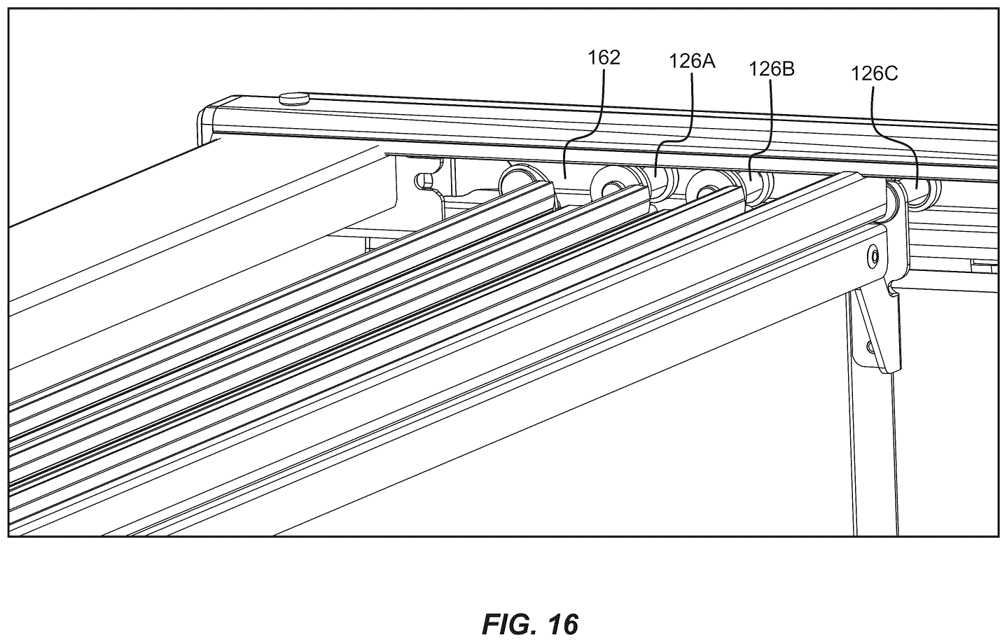

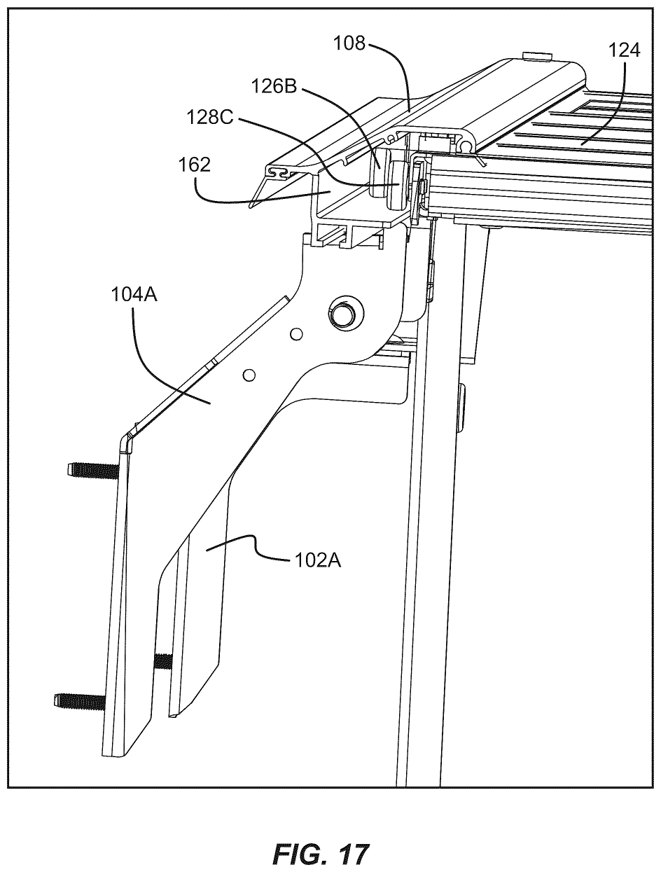

Thereafter, the panels 124 can be installed in a manner similar to that described by U.S. Pat. Nos. 6,321,819; 9,707,833; and 9,296,285, the contents of which are incorporated by reference to the extent that they do not conflict with the teachings herein. As depicted in FIGS. 12 and 13A-B, in one embodiment, the panels 124 include six panel members 160A-F hingedly coupled together, with environmental seals positioned between each of the panels 160A-F to inhibit moisture intrusion into the interior 62 of the pickup truck box 52 when the retractable cover system is in the closed position. As further depicted in FIGS. 14A-B, the panels 124 can include a pin 125, which can be positioned within an aperture 127 defined by at least one of the rail 108, 110 or front cross piece 106. As depicted in FIG. 15, in some embodiments, a locking member 129 can be configured to retain the pin 125 within the aperture 127. Thereafter, as depicted in FIGS. 16 and 17, a plurality of long bearings 126A-C and a plurality of short bearings 128A-C, can be positioned within a bearing channel 162 defined by each of the rails 108, 110.

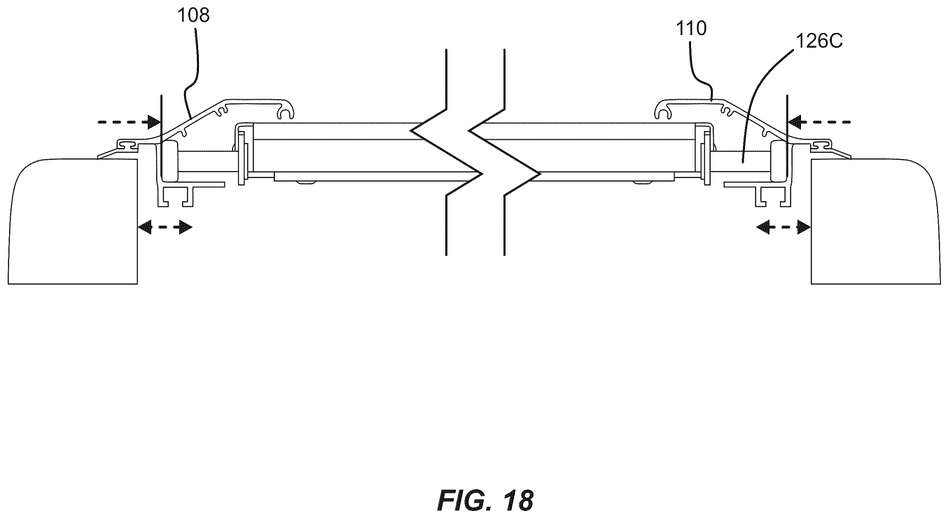

With the fasteners securing the rails 108, 110 to the brackets 102A-B, 104A-B still in a partially secured state, and the panels 124 in the closed position, the long bearings 126C will force the rails 108, 110 apart in a lateral direction to the appropriate distance necessary to ensure smooth operation of the panels 124 between the closed position and the open position (as best depicted in FIG. 18). A longitudinal position of the rails 108, 110 can be set to a predetermined distance from the tailgate 59. In some embodiments, the fork 306 of the installation tool 300 can be inserted into the bearing channel 162 of each rail 108, 110, such that with the tailgate 59 closed, a thickness of the installation tool 300 can be used to establish the predetermined distance D3 between the tailgate 59 and the rails 108, 110. Thereafter, the fasteners securing the rails 108, 110 to the brackets 102A-B, 104A-B can be tightened so as to generally lock the rails 108, 110 in place relative to the pickup truck box, thereby completing assembly of the retractable cover system 100.

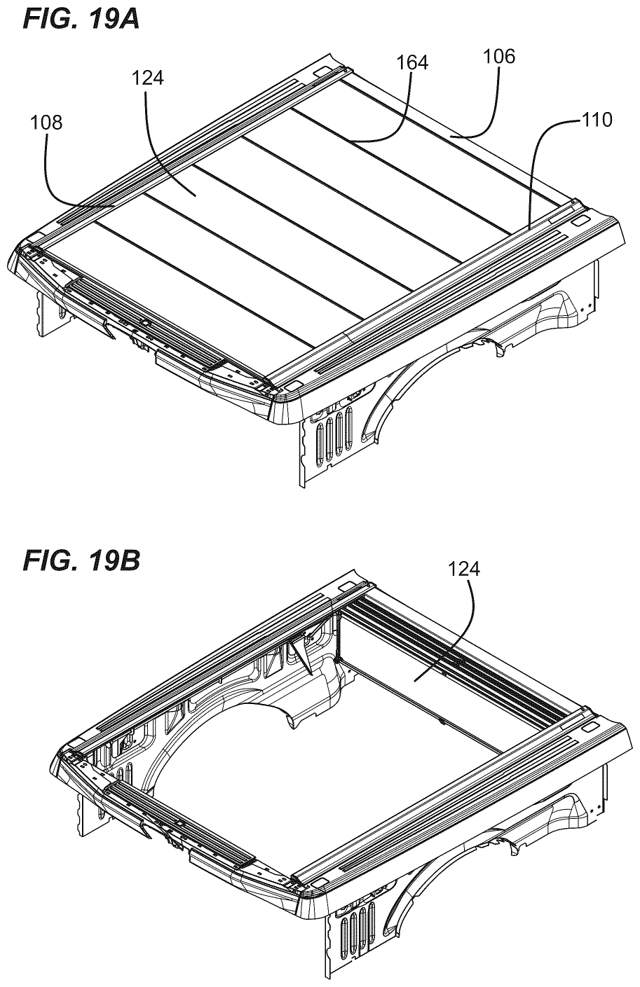

FIG. 19A depicts the installed retractable cover system 100 in a closed configuration, while FIG. 19B depicts the installed retractable cover system 100 in an open configuration. Installation of the retractable cover system 100 can advantageously be assembled piece-by-piece within the pickup truck box 52, as opposed to assembly of the crossmember and rails outside of the pickup truck box as is required in retractable cover systems of the prior art. Moreover, as the assembled cross members and rails of the prior art must be carefully lifted into the pickup truck box 52 without bending the connection point between the crossmember and rails, assembly of prior art cover systems typically required two people for successful completion. By contrast, as the various components of the retractable cover system 100 are installed directly into the pickup truck box 52, installation of the retractable cover system 100 can be completed by a single person. Further, as the brackets 102A/B, 104A/B defines slots 130A-B, 132A-B that enable ease in vertical adjustment of the brackets 102A/B, 104A/B relative to the top perimeter 60 (e.g., potentially with the aid of the installation tool 300), installation of the retractable cover system 100 can typically be accomplished in a time span of between about 30-45 minutes, which represents a significant time savings over installation of cover systems of the prior art.

Advantageously, the retractable cover system 100 is automatically locked any time that panels 124 are transitioned to the closed position, thereby eliminating the need for a user to separately lock the panels 124, as is generally required with cover systems of the prior art. This feature is enabled through interaction between the short bearings 128A of the panels 124 and the lift ramps 120, 122 (manipulated through the pushrods 116/118). In some embodiments, locking of the retractable cover system 100 is completed through a two-step process. The first step of the process involves sliding the panels 124 generally toward the tailgate end of the pickup truck box 52, which causes the panels 124 to transition from a folded orientation in which the panels 124 are generally stacked in an accordion configuration (depicted in FIG. 19B) to a generally planar orientation in which the panels 124 arranged to create a flat upper surface (depicted in FIG. 19A).

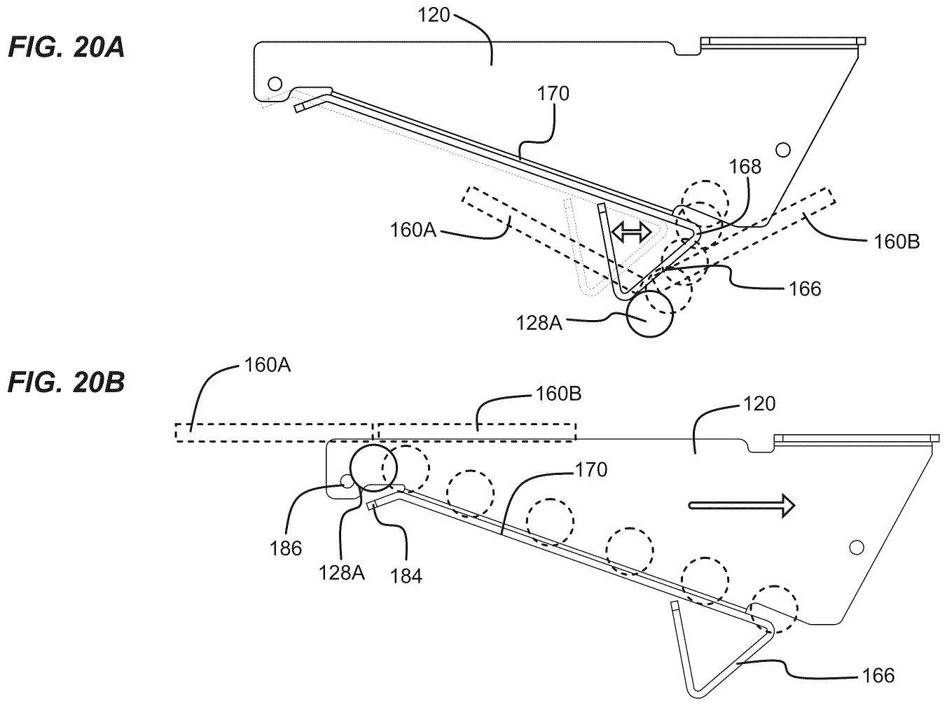

As the panels 124 transition from the folded orientation towards the generally planar orientation, a joint 164 located between a first panel 160A and a second panel 160B (occasionally referred to as the “A/B joint”) is positioned in proximity to the lift ramps 120, 122. As depicted in FIG. 20A, a hinged coupling between the first panel 160A and the second panel 160B, which can include a short bearing 128A, that interacts with the lift ramp 120. During the first step, the bearing 128A makes contact with a first ramp portion 166 of the lift ramp 120. Continued pulling on the panels 124 toward the tailgate causes the bearing 128A to exert a force against the first ramp portion 166, which causes the lift ramp 120 to temporarily shift generally toward the forward end 53 of the pickup truck box 52 (e.g., against the bias of the spring) from a first position to a second position, thereby enabling the bearing 128A to roll generally upwardly along the first ramp portion 166 and around a corner 168. Once the bearing 128 has cleared the corner 168, the lift ramp 120 can shift back to the first position generally toward the tailgate 59 of the pickup truck box 52, such that the bearing 128A is positioned on a second ramp portion 170 of the lift ramp 120.

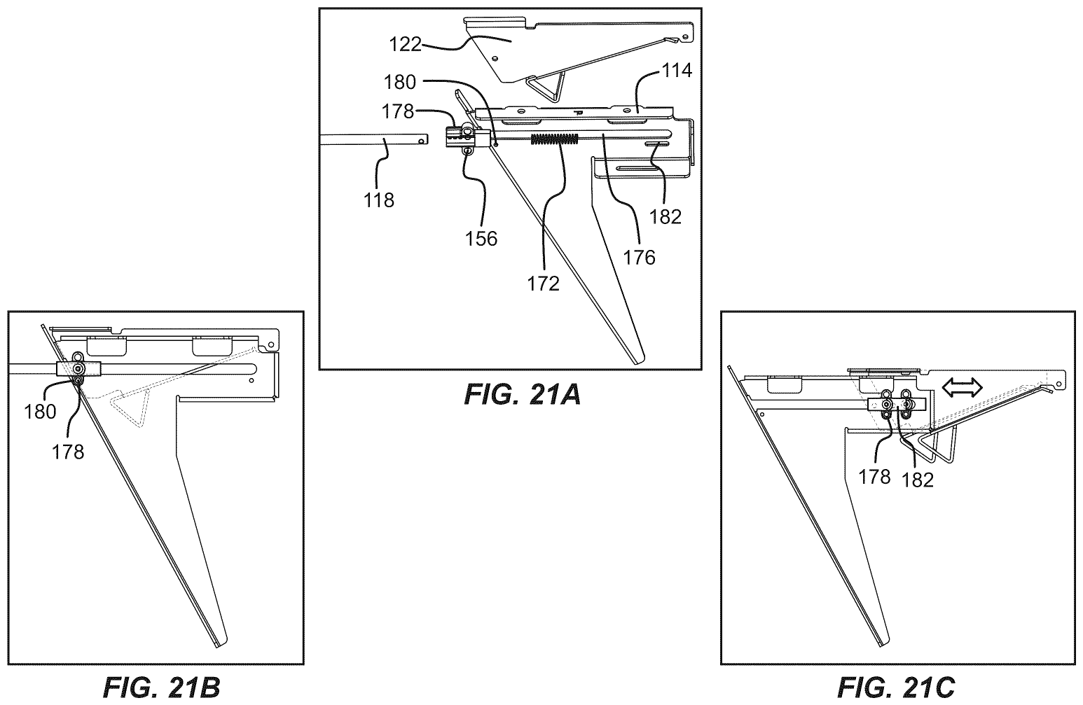

With additional reference FIG. 21A, in some embodiments, movement of the lift ramp 120 to enables the bearing 128A to move from the first ramp portion 166, around corner 168, to the second ramp portion 170 can be facilitated by a biasing member 172. Lift ramp 122 can be operably coupled to the pushrod 118 through a slot 176 defined within the stationary ramp 114. A slider mechanism 156 can be positioned on an end of the push rod 118. In some embodiments, the slider mechanism 156 can include a protrusion 178 configured to interact with first and second detents 180, 182 defined within the stationary ramp 114, such that when the pushrod 118 is pulled towards the tailgate 59 the protrusion 178 resides within the first detent 180 (as depicted in FIG. 21B), and when the push rod 118 is pushed towards the forward end 53 the protrusion 178 resides within the second detent 182 (as depicted in FIG. 21C).

In embodiments, the second detent 182 can be defined as a slot, wherein the biasing member 172 (e.g., coil spring, etc.) biases the slider mechanism 156 towards a tailgate end of the second detent 182. Force exerted against the first ramp portion 166 of the lift ramp 120 can cause the slider mechanism 156 (coupled to both the pushrod 118 and bearing 128) to temporarily shift towards the forward end of the second detent 182 against the bias of the biasing member 172. When the force is removed, the biasing member 172 shifts the slider mechanism 156 back towards the tailgate end of the second detent 182.

As depicted in FIG. 20B, with the bearing 128A positioned on the second ramp portion 170, the second step of the locking process can begin. During the second step, the pushrod 116 is pulled towards the tailgate end of the pickup truck box 52, thereby causing the operably coupled lift ramp 120 to shift towards the tailgate 59, which in turn causes the bearing 128A to traverse along the second ramp portion 170 until the bearing 128A falls off an end 184 of the second ramp portion 170 into contact with a stop 186. In this position, the protrusion of the pushrod 116 resides within the first detent 180, and the bearing 128A is securely cradled between an end 184 of the second ramp portion 170 and the stop 186, thereby effectively locking the retractable cover system 100 in the closed position. In some embodiments, a position of the stop 186 can be adjusted to modify the over center departure angle of the bearing 128A cradle position relative to the final position of the bearing 128 on the second ramp portion 170.

In embodiments, the retractable cover system 100 can be unlocked by completing the previously described two-step process in the reverse order. That is, first the pushrod 116 can be pushed toward the forward end 53 of the pickup truck box 52, thereby shifting the lift ramp 120 forward relative to the bearing 128A. Shifting the lift ramp 120 forward causes the bearing 128 to move from the cradled position (e.g., between the stop 186 and the end 184 of the second ramp portion 170) back onto the second ramp portion 170.

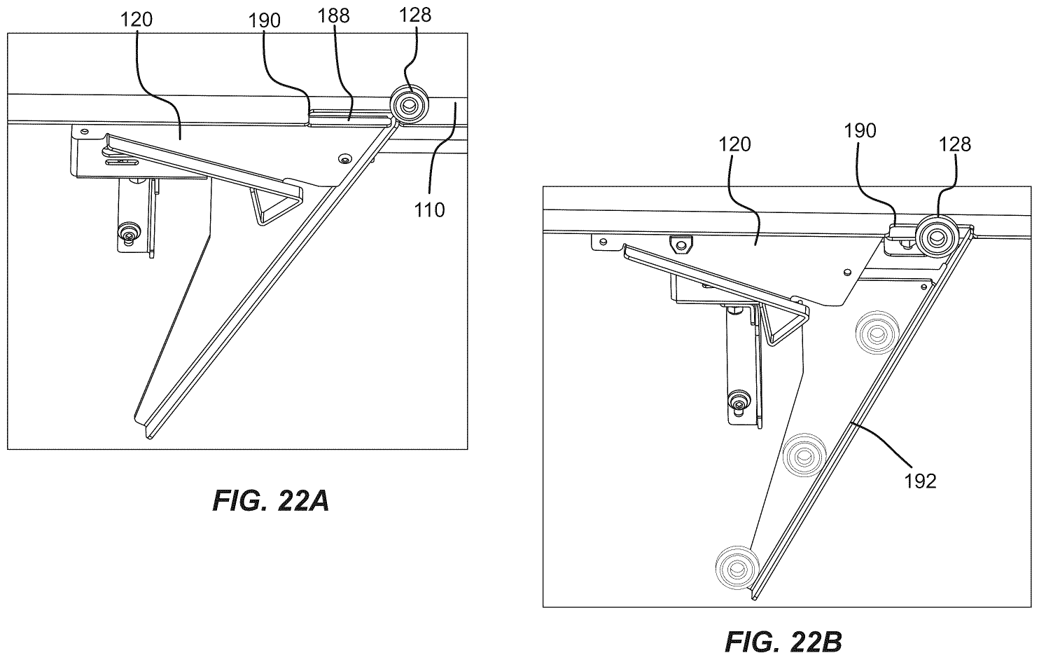

As further depicted in FIGS. 22A-B, as the lift ramp 120 is shifted from the aft position (as depicted in FIG. 13A) to the forward position (as depicted in FIG. 13B), a bearing surface 188 of the lift ramp 120 is shifted towards the forward end 53 of the pickup truck box, thereby opening a bearing aperture 190 defined in the rail 110, thereby enabling the short bearings 128 to pass therethrough. Thereafter, the panels 124 can be transitioned further towards the folded orientation in which the panels 124 are generally stacked in an accordion configuration, with the long bearings 126 retained on the rail 110, and the short bearings 128 falling through the bearing aperture 190 and being guided along a third ramp surface 192 defined by the stationary ramp 112. Accordingly, the retractable cover system 100 can be unlocked or partially opened from the tailgate, without having to walk around the side of the pickup truck 50 to push on the A/B joint, as is required with many cover systems of the prior art.

Further, in some embodiments, the retractable cover system 100 can be maintained in a partially opened/closed position, with at least one of the short bearings 128 having passed through the bearing aperture 190, and the remaining short bearings 128 positioned on the rail 110. To inhibit the short bearings 128 positioned on the rail 110 from falling through the bearing aperture 190, the pushrod 116 can be manipulated to shift the lift ramp 120 back to the aft position, thereby positioning the bearing surface 188 over the bearing aperture 190. In this manner, the retractable cover system 100 can be retained in a partially opened configuration.

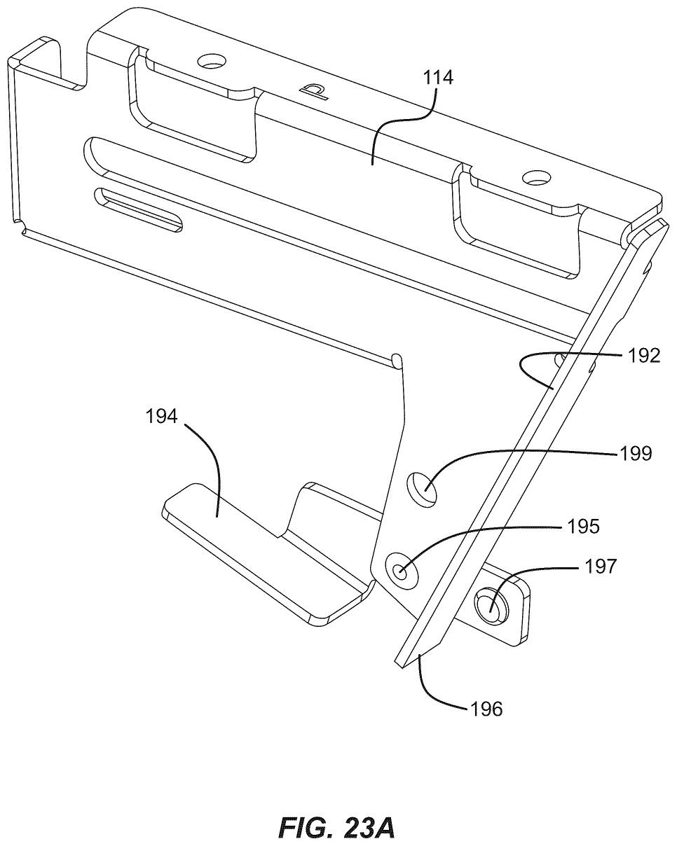

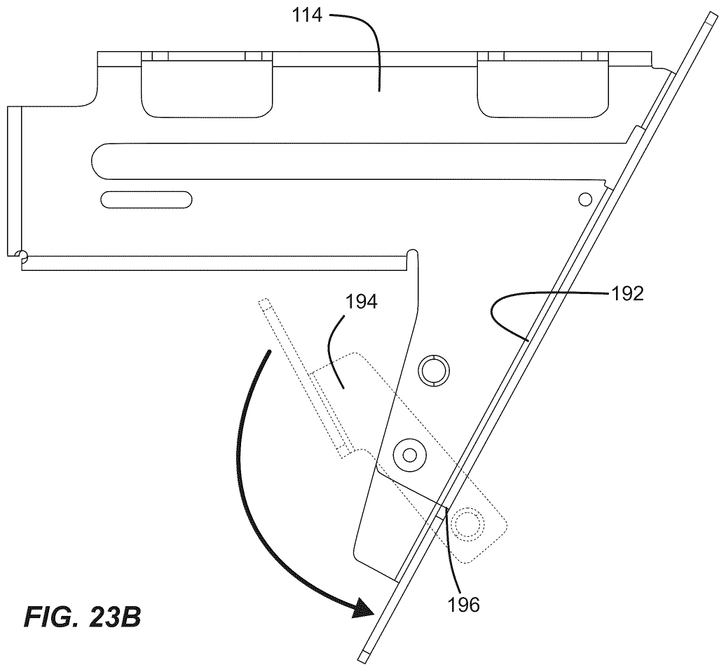

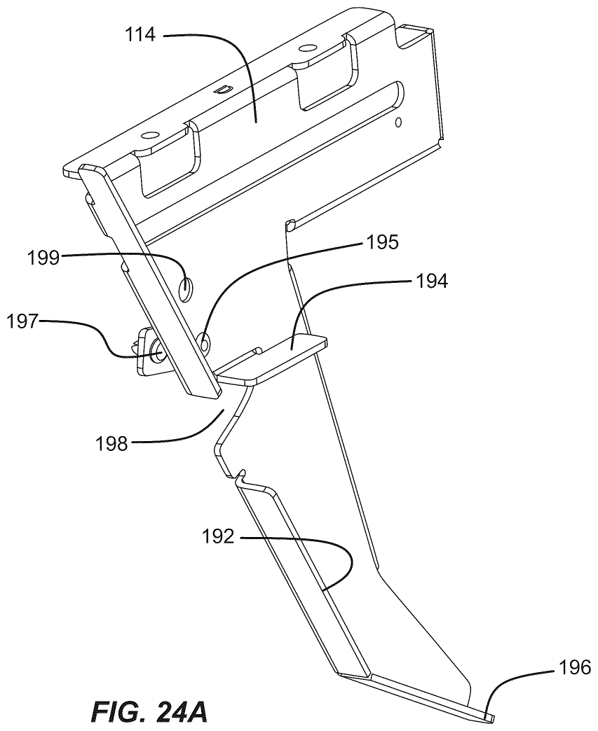

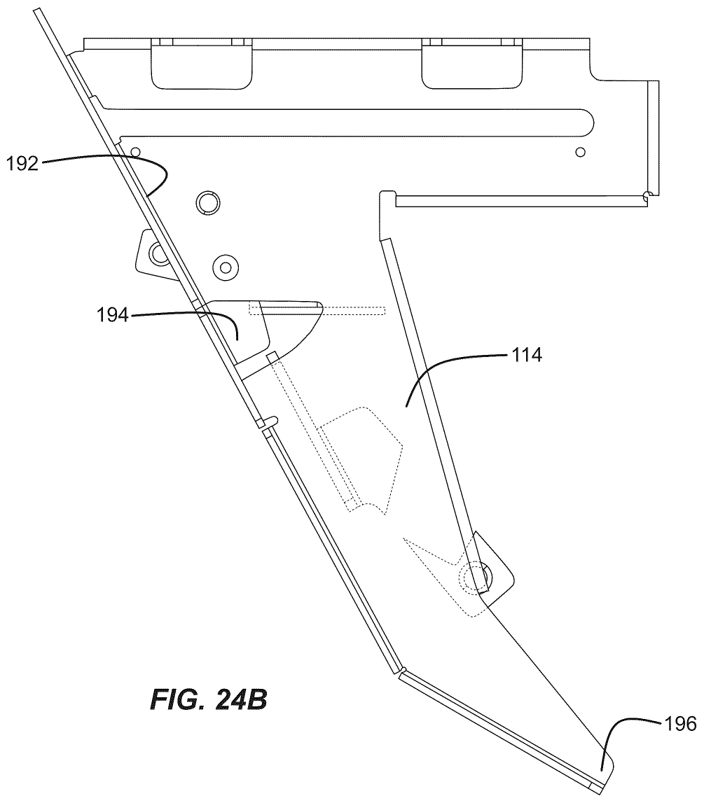

In certain embodiments, the third ramp surface 192 in FIGS. 23A-B and FIGS. 24A-B may include a movable ramp surface 194. When installing the retractable cover system 100, some panels 124 may initially be positioned on the opposite side of the stationary ramp 114 that is typically required for operation. Ordinarily, the panels 124 are positioned so that the bearings 126 can be guided along the third ramp surface 192 when transitioning between the open and closed positions. However, during initial installation, one or more panels 124 may be initially positioned on the opposite side of the stationary ramp 114. Therefore, it may be necessary to move the bearings 126 to the opposite side of the stationary ramp 114 to complete the installation. Sometimes, completing this transition requires temporarily flexing or bending the panels 124 to allow the bearings 126 to clear a distal end 196 of the third ramp surface 192.

To address this issue, certain embodiments include a movable ramp surface 194 integrated into the stationary ramp 114. This movable ramp surface 194 can be selectively moved (e.g., pivoted) relative to the third ramp surface, thereby allowing the bearings 126 to pass through a passageway 198 defined in the third ramp surface 192. The movable ramp surface 194 can be pivotably coupled to the stationary ramp 114 using a pivot 195 (e.g., rivet, fastener, etc.). In some embodiments, the movable ramp surface 194 is positioned near the distal end 196 of the third ramp surface 192 (as shown in FIGS. 23A-B). In other embodiments, the movable ramp surface 194 may be located at an intermediary position along the third ramp surface 192 (as shown in FIGS. 24A-B).

Consequently, in certain embodiments, the movable ramp surface 194 can transition between an open position where a bearing 126 can pass through the passageway 198 in the third ramp surface 192, and a closed position where the movable ramp surface 194 aligns with the third ramp surface 192 to form a planar surface capable of supporting the bearings 126. To secure the movable ramp surface 194 in the closed position, some embodiments utilize a protrusion 197 on the movable ramp surface 194 that extends into a detent 199 defined by the stationary ramp, although in other embodiments, the positions of the protrusion 197 and detent 199 can be reversed. In order to ensure smooth operation, the protrusion 197 may be made of a softer material like plastic in certain embodiments.

The various examples described above are provided by way of illustration only and should not be construed to limit the scope of the present disclosure. Those skilled in the art will readily recognize various modifications and changes that may be made with respect to the examples illustrated and described herein without departing from the true spirit and scope of the present disclosure.

What is claimed is:

1. A retractable cover system, comprising:
a plurality of brackets mountable within a box of a pickup truck;
a driver side rail and a passenger side rail operably couplable to the plurality of brackets;
a plurality of panels having a plurality of bearings configured to engage the driver side rail and the passenger side rail to transition between an opened position and a closed position; and
a front cross piece operably coupling the driver side rail to the passenger side rail, wherein the front cross piece includes a leading edge defining a curve generally conformed to at least one of a forward end of the box or a rear of a cab of the pickup truck.

2. The retractable cover system of claim 1, wherein a variance in a gap distance between the curve and the at least one of the forward end of the box or the rear of a cab of the pickup truck is less than or equal to about ½ inch.

3. The retractable cover system of claim 1, wherein the front cross piece is a monolithically formed member.

4. The retractable cover system of claim 1, wherein the front cross piece is constructed of sheet metal.

5. The retractable cover system of claim 1, wherein the front cross piece serves as a mounting surface for accessories.

6. The retractable cover system of claim 1, wherein the front cross piece form a bridge between the driver side rail and the passenger side rail capable of supporting a load of at least 100 pounds.

7. The retractable cover system of claim 1, wherein the front cross piece is configured to inhibit intrusion of moisture into the box of the pickup truck.

8. The retractable cover system of claim 1, further comprising a seal positionable between the front cross piece and a top surface of a forward end of the box of the pickup truck.

9. A method of installing a retractable cover system, comprising:
mounting a plurality of brackets within a box of a pickup truck, wherein each bracket of the plurality of brackets includes a slot through which a fastener coupling the mounting bracket to the box of a pickup truck is positionable to aid in ease of adjustment of a top surface of each bracket relative to a top perimeter of the box of the pickup truck;
operably coupling a driver side rail and a passenger side rail to the plurality of brackets;
operably coupling a front cross piece to the driver side rail to the passenger side rail;
operably coupling one or more push rods and one or more lift ramps to the plurality of brackets; and
operably coupling a plurality of panels to the driver side rail and a passenger side rail.

10. The method of claim 9, wherein the plurality of brackets include a pair of cab brackets mountable to a forward portion of a driver side wall and a passenger side wall of the box, and a pair of tailgate brackets mountable to an aft portion of the driver side wall and the passenger side wall of the box.

11. The method of claim 9, wherein each of the plurality of brackets is mountable to a feature defined within the box of the pickup truck, such that no permanent modifications to the box are necessary to mount the plurality of brackets within the box of the pickup truck.

12. The method of claim 9, wherein the feature is at least one of a gear tiedown or threaded aperture.

13. The method of claim 9, the plurality of brackets are mounted to the box in a manner that enables continued use of the feature after complete installation of the retractable cover system.

14. The method of claim 9, wherein each of the plurality of brackets are adapted to be operably coupled to features defined within the box of particular pickup truck make and model.

15. The method of claim 9, wherein the make and models is one of a Ford F150, Ford F250, Ford F350, Ford F450, Ford Ranger, Ford Raptor, Ford Sport Trac, Chevrolet Colorado, Chevrolet S-10, Chevrolet Silverado 1500, Chevrolet Silverado 2500, Chevrolet Silverado 3500, GMC Canyon, GMC Sierra 1500, GMC Sierra 2500, GMC Sierra 3500, GMC Sonoma, Dodge Ram 1500, Dodge Ram 2500, Dodge Ram 3500, Nissan Titan, Nissan Frontier, Toyota Tacoma, Toyota Tundra, Honda Ridgeline, or Lincoln Mark LT.

16. The method of claim 9, further comprising adjusting a top surface of each bracket relative to a top perimeter of the box of the pickup truck with the aid of an installation tool.

17. The method of claim 9, wherein the installation tool includes a first member extending along a first axis, with a second member extending along a second axis substantially orthogonal to the first axis, wherein the first member defines a shoulder and a terminal end and wherein a distance between the second member and the shoulder is used a benchmark to establish a first distance for spacing of at least one of the plurality of brackets, and a distance between the second member and the terminal end is used a benchmark to establish a second distance for spacing of at least one of the plurality of brackets.

18. The method of claim 9, wherein a thickness of the first member is used as a benchmark to establish a third distance for positioning the driver side rail and the passenger side rail relative to the plurality of brackets.

19. A retractable cover system, comprising:
a plurality of panels including a plurality of bearings received within a driver side rail and a passenger side rail, the plurality of panels transitionable relative to the driver side rail and the passenger side rail between an open position and a closed position; and
at least one lift ramp shiftable relative to the driver side rail and the passenger side rail between a first transition position, a second transition position and a locked position,
wherein in the first transition position an applied force on the plurality of panels causes a first bearing of the plurality of bearings to contact a first ramp surface of the at least one lift ramp to shift the at least one lift ramp from the first transition position to the second transition position against a bias of a biasing member,
wherein in the second transition position the first bearing moves from the first ramp surface to a second ramp surface and the bias of the biasing member shifts the at least one lift ramp back to the first transition position, and
wherein manipulation of the at least one lift ramp from the first transition position to the locked position causes the first bearing to depart an end of the second ramp into a cradle position, thereby locking the plurality of panels the closed position.

20. The retractable cover system of claim 19, wherein in the cradle position the first bearing is supported by an end of the second ramp and a stop.

21. The retractable cover system of claim 19, wherein a position of the stop is adjustable relative to the end of the second ramp to tune a locking position of the first bearing.

22. The retractable cover system of claim 19, wherein the first ramp surface and the second ramp surface are positioned at an acute angle relative to one another, wherein a corner is defined between the first ramp surface and the second ramp surface.

23. The retractable cover system of claim 19, wherein the at least one lift ramp is manipulated by a push rod.

24. The retractable cover system of claim 19, wherein the at least one lift ramp is maintained in the locked position with the aid of a protrusion of a slider mechanism residing within a first detent, and maintained in the first transition position and the second transition position with the aid of the protrusion residing within a second detent.

25. The retractable cover system of claim 24, wherein the second detent is configured as a slot to enable the at least one lift ramp to shift between the first transition position and the second transition position against the bias of the biasing member.

26. The retractable cover system of claim 19, wherein the biasing member is a coil spring.

27. A retractable cover system, comprising:
a plurality of panels including a plurality of bearings received within a driver side rail and a passenger side rail, the plurality of panels transitionable relative to the driver side rail and the passenger side rail between an open position and a closed position; and
at least one lift ramp shiftable relative to the driver side rail and the passenger side rail between a locked position and a transition position, wherein manipulation of the at least one lift ramp from the locked position to the transition position causes a first bearing of the plurality of bearings to transition from a cradle position to an unlocked position along a ramp surface of the at least one lift ramp.

28. The retractable cover system of claim 27, wherein the at least one lift ramp defines a bearing surface, and wherein shifting the at least one lift ramp from the locked position to the transition position causes the bearing surface to shift relative to the driver side rail to open bearing aperture, thereby enabling at least a portion of the plurality of bearings to pass therethrough.

29. The retractable cover system of claim 27, wherein the at least one lift ramp is shifted by a push rod.

30. The retractable cover system of claim 27, wherein the at least one lift ramp is maintained in the locked position with the aid of a protrusion of a slider mechanism residing within a first detent, maintained in the transition position with the aid of the protrusion residing within a second detent.

31. The retractable cover system of claim 27, further comprising a stationary ramp defining a ramp surface configured to aid in guiding the at least a portion of the plurality of bearings passing through the open bearing aperture.

32. The retractable cover system of claim 31, wherein the stationary ramp defines a movable surface portion configured to be selectively moved relative to the ramp surface, thereby enabling at least one bearing of the plurality of bearings to pass therethrough.
